(19) United States
(12) Patent Application Publication
(10) Pub. No.: US 2006/0129764 A1
(43) Pub. Date: Jun. 15, 2006

(54) Methods and apparatus for storing a command

(75) Inventors: Mark D. Bellows, Rochester, MN (US); Paul A. Ganfield, Rochester, MN (US); Lonny J. Lambrecht, Byron, MN (US)

Correspondence Address: Leslie Payne;IBM Corporation, Intellectual Property Law Dept. 917, 3605 Hwy. 52 North, Rochester, MN, 55901, US

(73) Assignee: INTERNATIONAL BUSINESS MACHINES CORPORATION, ARMONK, NY (US)

(21) Appl. No.: 11/008,768

(22) Filed: Dec. 9, 2004

(51) Int. Cl. G06F 13/00

(52) U.S. Cl. 711/125

(57) ABSTRACT

In a first aspect, a first method is provided for storing a command. The first method includes the steps of (1) receiving a new command referencing an address; (2) determining whether the new command is dependent on at least one previously-received command referencing the address stored in a queue of pending commands; (3) identifying the most-recently received command of the at least one previously-received command; and (4) associating the new command with the most-recently received command of the at least one previously-received command. Numerous other aspects are provided.

### FIELD OF THE INVENTION

The present invention relates generally to a computer system, and more particularly to methods and apparatus for storing a command with a computer system.

### BACKGROUND

Commands referencing the same address may be received by a computer system or the like, stored in one or more respective queues and executed out of the order in which such commands are received. However, if the computer system executes such commands out of order, the computer system must track dependency of such commands to ensure each command receives correct data (e.g., the data received by each command if the commands are executed in order). Further, because a command stored in a queue may be removed from the queue before execution, the computer system should accommodate such removal. In conventional computer systems, tracking dependency of a command stored in an entry of a queue and accommodating removal of a command stored in the queue before execution requires a complicated hardware design that occupies a large area.

Improved methods and apparatus for performing such command storing and removal operations are desirable.

### SUMMARY OF THE INVENTION

In a first aspect of the invention, a first method is provided for storing a command. The first method includes the steps of (1) receiving a new command referencing an address; (2) determining whether the new command is dependent on at least one previously-received command referencing the address stored in a queue of pending commands; (3) identifying the most-recently received command of the at least one previously-received command; and (4) associating the new command with the most-recently received command of the at least one previously-received command.

In a second aspect of the invention, a first apparatus is provided for storing a command. The first apparatus includes (1) a processor; (2) a main memory; and (3) logic for storing a queue of pending commands. The logic includes a memory and is coupled to the processor and main memory. The logic is adapted to (a) receive a new command referencing an address; (b) determine whether the new command is dependent on at least one previously-received command referencing the address stored in the queue of pending commands; (c) identify the most-recently received command of the at least one previously-received command; and (d) associate the new command with the most-recently received command of the at least one previously-received command. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of an apparatus for storing a command in accordance with an embodiment of the present invention.

FIG. 2 is a block diagram of logic included in the apparatus for storing a command in accordance with an embodiment of the present invention.

FIG. 3 illustrates a method for storing a command in accordance with an embodiment of the present invention.

### DETAILED DESCRIPTION

A first command (e.g., referencing an address) may depend on a second command (e.g., referencing the same address) if the first command requires the second command to complete execution before the first command may execute. The present invention provides methods and apparatus for tracking dependency of commands referencing the same address. A computer system or the like may implement a read queue and/or a write queue, each of which includes a plurality of entries, for storing commands. In conventional systems, an entry of a read queue may include a bit for each write queue entry on which a command stored in the read queue may depend. Further, an entry of a write queue may include a bit for each read and remaining write queue entry on which a command stored in the write queue may depend. For computer systems that support a large number of queue entries, a large number of such bits must be stored, and consequently, a large amount of hardware for storing such bits is required.

In contrast, according to the present methods and apparatus, an entry of a read or write queue may include a bit (e.g., a dependency valid bit) or an encoding of a state indicating whether the command stored in the entry is dependent on another command (e.g., whether such command requires another command to complete execution before the command may execute), and a pointer for storing the number of the queue entry storing such other command. Further, the entry of the read or write queue may include a bit (e.g., a linked bit) for indicating whether another command depends on the command stored in the entry. According to the present methods and apparatus, when a new command is received, logic may be employed to set such bits and pointer. For example, when a new command is received and the read and/or write queues include multiple previously-received commands on which the new command depends, the logic may set (e.g., assert) the dependency valid bit and set the pointer to the number of the queue entry storing the most-recently received command of such previously-received commands on which the new command depends. The logic may employ linked bits associated with respective commands already stored in the queue to identify the most-recently received command on which the new command depends. In this manner, command dependency may be tracked by forming a single linked list.

In at least one embodiment, only a command stored in a queue entry in which the dependency valid bit is not set may be selected for execution. Once such a command is selected and/or executed, a dependency valid bit of any entries whose pointer includes the number of the entry from which the command was executed is reset (e.g., deasserted).

Further, according to the present methods and apparatus, a queue entry may include a bit (e.g., an invalidate pending bit) for identifying a command for removal from the queue (e.g., before execution). The computer system (e.g., memory controller 106) may select for removal a command in a queue entry in which the invalidate pending bit is set (e.g., asserted) and dependency valid bit is not set. Once such command is selected for removal, a dependency valid bit of any entries whose pointer includes the number of the entry from which the command is selected for removal are reset (e.g., deasserted).

By employing the bits and pointer described above, the present methods and apparatus may reduce an overall number of bits required to track dependencies of commands referencing the same address stored in one or more queues and/or accommodate removal of a command stored in a queue before execution, thereby reducing an area required by such methods and apparatus.

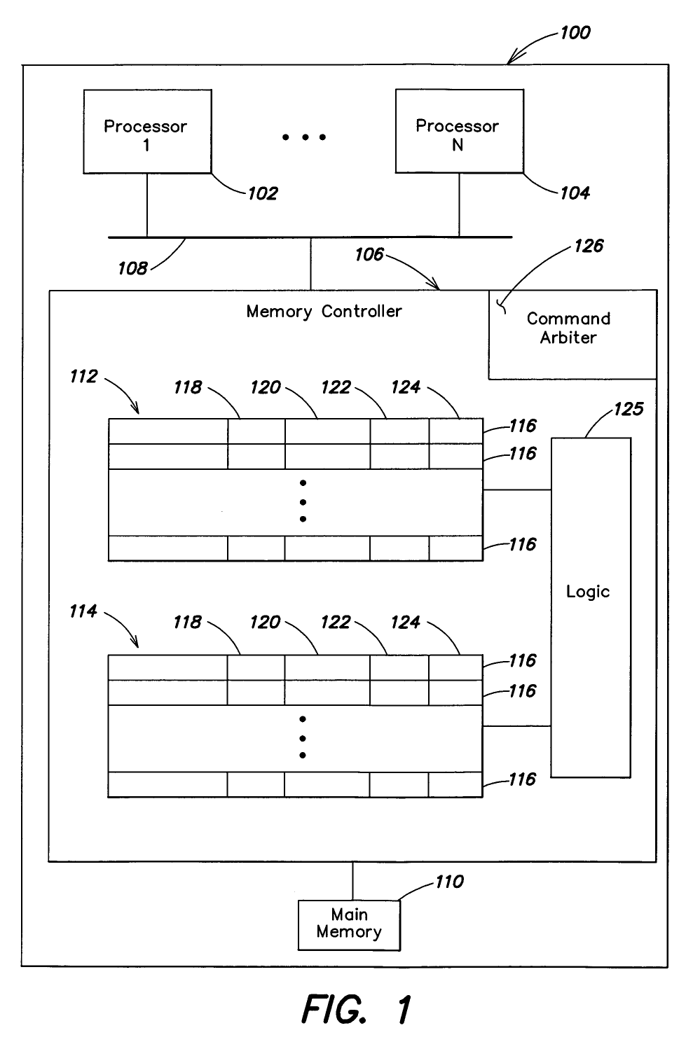

FIG. 1 is a block diagram of an apparatus for storing a command in accordance with an embodiment of the present invention. With reference to FIG. 1, the apparatus 100 for storing a command may be a computer system or the like. The apparatus 100 may include one or more processors 102-104 coupled to a memory controller 106 via a bus 108. The memory controller 106 may be coupled to a memory (e.g., main memory) 110. The memory controller 106 may include any suitable combination of logic, registers, memory or the like. A processor 102-104 may output a command referencing an address of the main memory 110 on the bus 108 and the memory controller 106 may receive such command. In response, the memory controller 106 may access such address of the main memory 110, thereby servicing the command.

The memory controller 106 may include one or more queues for storing commands before the commands are serviced (e.g., while the commands are pending). For example, the memory controller 106 may include one or more read queues 112 (only one shown) and one or more write queues 114 (only one shown) for storing pending commands. In one embodiment, the memory controller 106 includes a read queue 112 and write queue 114 with thirty-two entries each (although the read queue 112 and/or the write queue 114 may include a larger or smaller number of entries). Therefore, the memory controller 106 may store up to sixty-four commands in the queues 112, 114. An entry 116 for storing a command of the one or more read queues 112 or one or more write queues 114 may include (e.g., store) a bit (e.g., a dependency valid bit 118) indicating whether the command stored in the entry 116 is dependent on another command stored in a read 112 or write queue 114 (e.g., whether such command requires another command to complete execution before the command may execute). For example, a read command referencing a main memory address may be dependent on a write command, which is received before the read command, referencing the same memory address. To ensure the read command accesses correct data from the memory address, execution of the write command to the address should complete before the read command is executed, and therefore, the dependency valid bit 118 of the entry storing the read command may be set.

If the dependency valid bit 118 included in an entry 116 of a queue 112, 114 indicates the command stored in such entry 116 depends on another command (e.g., if the dependency valid bit 118 is set), the entry 116 includes a pointer 120 storing the number of the queue entry 116 storing such other command. Further, an entry 116 in a read 112 or write queue 114 may include a bit (e.g., a linked bit 122) for indicating whether another command (e.g., a pending command) depends on the command stored in the entry 116. In this manner, a priority may be assigned to a command (e.g., a write command) stored in such entry 116 compared to other pending commands stored in queue 112, 114 that may not have commands which depend on them. Additionally or alternatively, an entry 116 for storing a command in the one or more read queues 112 or one or more write queues 114 may include a bit (e.g., an invalidate pending bit 124) for identifying a command for removal from the queue (e.g., before execution). The computer system 100 (e.g., memory controller 106) may select for removal a command stored in a queue entry 116 in which the invalidate pending bit 124 is set and dependency valid bit 118 is not set.

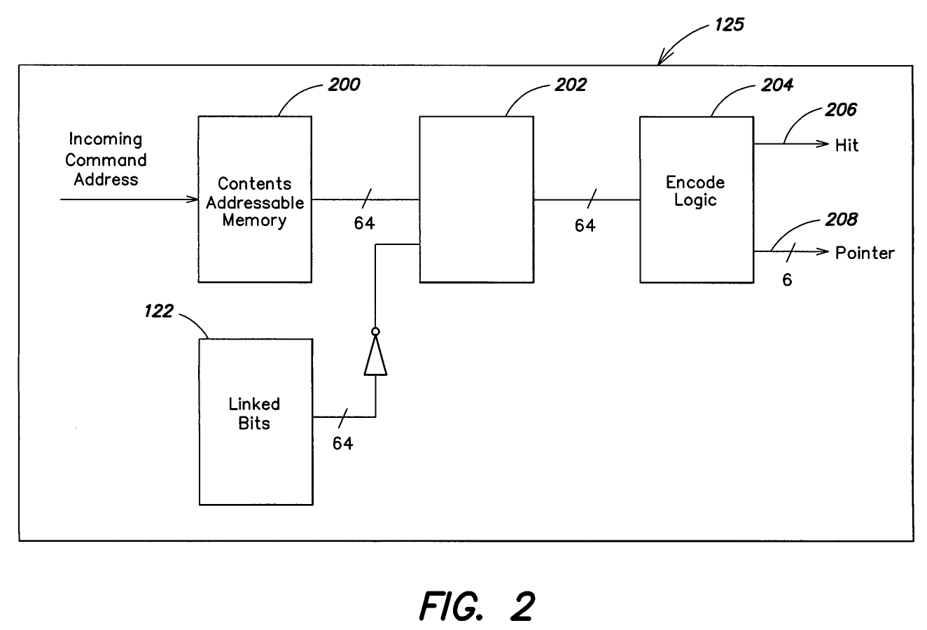

The memory controller 106 includes logic 125 (e.g., any suitable combination of logic devices, registers, memory or the like) for determining and/or adjusting a value of the bits and pointer described above corresponding to an entry 116 of a queue 112, 114 as one or more commands are received and/or executed by the computer system 100 (e.g., memory controller 106). More specifically, the logic 125 may determine and/or adjust a value of the dependency valid bit 118, pointer 120, linked bit 122 and/or invalidate pending bit 124 as one or more read or write commands are received and/or executed by the computer system 100 (e.g., memory controller 106). In this manner, the computer system 100 (e.g., memory controller 106) may employ a single linked list of pending commands referencing the same address that may accommodate removal of a pending command from the single linked list before execution of such command. Details of the logic 125 are described below with reference to FIG. 2.

The memory controller 106 may include and/or be coupled to a command arbiter 126 for selecting a command for servicing from one of the read 112 or write queues 114. Additionally or alternatively, the command arbiter 126 may select a command for removal from a read 112 or write queue 114 (e.g., before execution).

FIG. 2 is a block diagram of logic included in the apparatus for storing a command in accordance with an embodiment of the present invention. With reference to FIG. 2, the logic 125 included in the apparatus 100 for storing a command (e.g., included in the memory controller 106) may include a memory 200, such as a contents addressable memory (CAM), for storing an entry corresponding to each queue entry 116. Therefore, one or more entries in the contents addressable memory 200 may include an address referenced by respective commands. For example, for the embodiment described above, the CAM 200 may include sixty-four entries. However, the CAM 200 may store a larger or smaller number of entries. Further, each CAM entry may store a queue valid indicating a corresponding queue entry is valid.

The CAM 200 may be adapted to perform a lookup by receiving input data, such as an address referenced by a command (e.g., an incoming command), and output an indication of entries of the CAM 200 that include such input data (e.g., the address). For example, the CAM 200 may output a bit corresponding to each CAM entry, which indicates whether such CAM entry includes the input data. Therefore, the CAM 200 may output sixty-four-bits (although the CAM 200 may output a larger or smaller number of bits). In this manner, each bit output by the CAM 200 indicates whether a CAM entry, which corresponds to a queue entry 116, includes data (e.g., an address) input by the CAM 200. A bit, which corresponds to a CAM entry that corresponds to a queue entry 116, output by the CAM 200 along with an inverted version of the linked bit 124 corresponding to the queue entry 116 are input by respective logic gates (not shown) included in logic 202 for performing a logic AND operation (or similar operation). In this manner, the logic 202 may output a bit corresponding to each queue entry 116. For example, in the embodiment described above, the logic 202 may output sixty-four bits. The logic 202 may be employed to mask (e.g., gate off) the identity of CAM entries storing queue entries, which include an address that matches the address input by the CAM 200, for all but the CAM entry storing the most recently received of such queue entries including the input address.

The output of logic 202 is coupled to an input of the encode logic 204. The encode logic 204 is adapted to output first data via a first output 206, such as a bit indicating whether a CAM entry includes the data input by the CAM 200 (e.g., whether a CAM “hit” occurs). Further, the encode logic 204 may output a plurality of bits as second data via a second output 208. The first data (e.g., indicating whether a CAM “hit” occurs) and second data may serve as the dependency valid bit 118, and pointer 120 indicating a queue entry number on which a command depends, respectively, for the new command. For example, in one embodiment, the pointer 120 may be six bits, the most significant bit of which indicates whether the pointer 120 includes an address of a read 112 or write queue 114, and the remaining bits of which indicate a queue entry 116 number. In this manner, the logic 125 may provide values for the dependency valid bit 118 and pointer 120 corresponding to a new command.

The logic 125 may provide a value for a linked bit 122 for one or more commands stored in a queue 112, 114. For example, when the logic 125 provides a value for the dependency valid bit 118 corresponding to a newly-received command to indicate such command depends on a previously-received command, the logic 125 may provide a value for the linked bit 122 corresponding such previously-received command. Additionally or alternatively, the logic 125 may provide a value for an invalidate pending bit 124 corresponding to one or more commands stored in the queues 112-114.

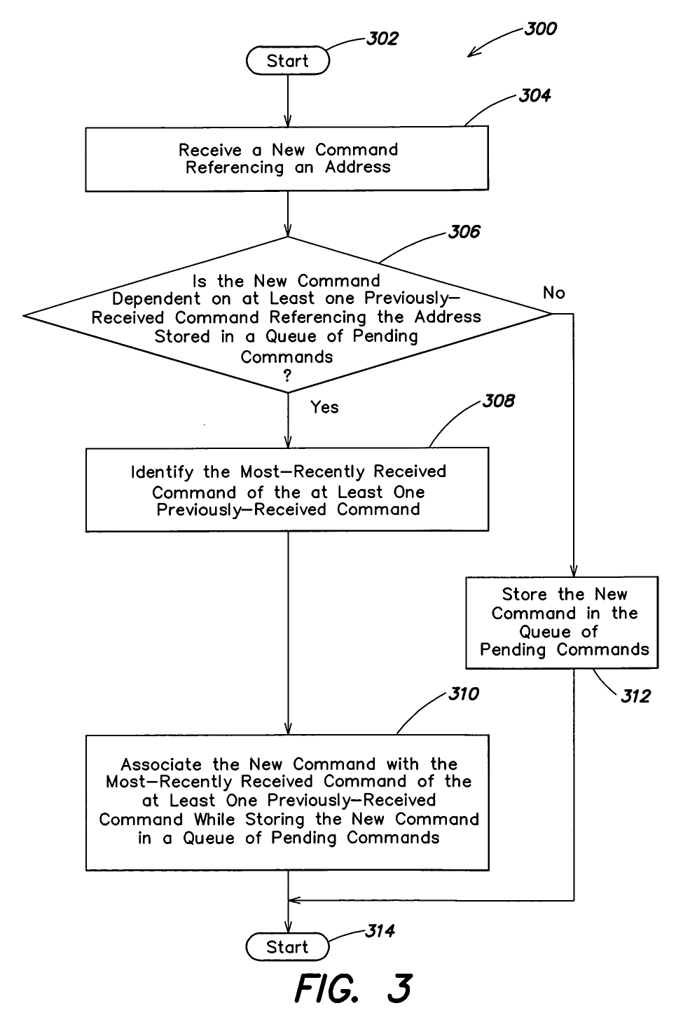

The operation of the apparatus 100 for storing a command is now described with reference to FIGS. 1-2, and with reference to FIG. 3 which illustrates a method for storing a command in accordance with an embodiment of the present invention. With reference to FIG. 3, in step 302, the method 300 begins. In step 304, a new command referencing an address is received. For example, a processor 102-104 may place a new command referencing a main memory address on the bus 108 and the memory controller 106 may receive such new command. The memory controller 106 may need to determine a location in which to store the new command while the new command is pending. Therefore, in step 306, it is determined whether the new command is dependent on at least one previously-received command referencing the address stored in a queue of pending commands. For example, the logic 125 of the memory controller 106 may determine whether the new command depends on a previously-received command that is stored a queue 112, 114 of pending commands. More specifically, the CAM 200 includes entries corresponding to queue entries 116, which may store pending commands. The CAM 200 inputs the address referenced by the new command and outputs a bit for each CAM entry indicating whether such CAM entry includes the address referenced by the new command. In this manner the CAM 200 may identify queue entries which store commands (e.g., previously-received commands) referencing the same address as the new command. Because commands stored in such identified queue entries reference the same address as a new command, the new command may be dependent on commands stored in one or more of such identified queue entries.

If in step 306, it is determined the new command is dependent on at least one previously-received command referencing the address stored in a queue of pending commands, step 308 is performed. In step 308, the most-recently received command of the at least one previously-received command is identified. The logic 125 may identify the most-recently received command of the at least one previously-received command. As stated the logic 125 may provide a linked bit 122 for the at least one previously-received command stored in a queue 112, 114. For example, if the memory controller 106 determines a newly-received command depends on a previously-received command, the linked bit 122 corresponding to the previously-received command may be set (e.g., asserted to a high logic state). In this manner, respective linked bits 122 corresponding to all commands referencing an address but the most-recently received command referencing the address may be asserted.

Because an inverted linked bit value corresponding to a queue entry 116 is input along with a bit output by the CAM 200 corresponding to a CAM entry, which corresponds to the queue entry, the logic 202 for performing a logic AND operation, serves to mask all bits corresponding to CAM entries that includes the address referenced by the new command except for the bit corresponding to the CAM entry that corresponds to the queue entry 116 storing the most-recently received command of the at least one previously-received command. More specifically, the logic 202 for performing a logic AND operation may output a plurality of bits only one of which is asserted. Such asserted bit corresponds to a CAM entry that corresponds to a queue entry storing the most-recently received of the at least one previously-received command to the same address. In this manner, commands with a set linked bit are excluded as an address match between the address input by the CAM 200 and addresses in CAM entries, and only the newest previously-received command referencing the address input by the CAM 200 will be identified as a match. Thus, the logic 125 identifies the most-recently received command of the at least one previously-received command.

In step 310, the new command is associated with the most-recently received command of the at least one previously-received command. More specifically, as stated the encode logic 204 may output six bits that serve as a pointer to a queue entry 116 storing the command identified as the most recently-received of the at least one previously-received command. The logic 125 may provide the pointer 120 to be stored in a queue entry 116 employed to store the new command, thereby associating the new command with the most-recently received command of the at least one previously-received command. As stated, the encode logic 204 may output first data that may serve as a dependency valid bit 118. More specifically, the logic 125 provides the first data to the queue entry 116 storing the new command as a dependency valid bit 118, thereby indicating that the new command depends on a command stored in a queue entry 116 indicated by the pointer 120. In this manner, the new command is stored in the queue of pending commands.

Thereafter, step 314 may be performed. In step 314, the method 300 ends.

Alternatively, if, in step 306, it is determined the new command is not dependent on at least one previously-received command referencing the address stored in a queue of pending commands, step 312 is performed. For example, if an address referenced by a new command is not included in a CAM entry, step 312 is performed. In step 312, the new command may be stored in an entry of a queue 112, 114. Because the new command is not dependent on at least one previously-received command stored in a queue 112, 114 of pending commands, the first data output by the encode logic 204 may be deasserted (e.g., of a low logic state). The logic 125 may provide the first data output by the encode logic 204 to a queue entry 116 employed for storing the new command to serve as a dependency bit 118 value, thereby indicating the new command does not depend on a previously-received command. The logic 125 may provide a null pointer value or a deasserted pointer value (e.g., of a low logic state) to the queue entry 116 storing the new command. Thereafter, step 314 may be performed in which the method 300 ends.

Additionally, as stated, the apparatus 100 may include a command arbiter 126 adapted to select a command from a queue 112, 114 for execution. The command arbiter 126 may select commands stored in queue entries 116 including a dependency valid bit 118 which is not set, for example, of a low logic state. Commands referencing an address may be stored in a single linked list of commands referencing the address in the manner described above. Therefore, the command arbiter 126 may select a command stored in a queue entry 116 including a dependency valid bit which is not set (e.g., a deasserted bit) from the single linked list of command referencing the address for execution. The logic 125 may determine that one or more queue entries 116 for storing respective commands include pointers 120 storing the number of the queue entry 116 that stores the command selected for execution, and reset the dependency valid bit 118 for the one or more queue entries 116, thereby disassociating such commands from the command selected for execution. The command selected for execution may be executed.

Additionally (or alternatively), a queue state may be associated with a command (e.g., a first command) stored in the queue of pending commands such that the command may be removed from the queue of pending commands, before execution, based on the queue state. The first command may be a command stored, for example, in the middle of a single linked list of commands referencing the same address. The memory controller 106 may receive a request to remove the first command from the linked list before execution. For example, the memory controller 106 may receive a request to retry the first command, which requires the first command to be removed from the queue. In response to a request to remove the first command from the queue 112, 114, the logic 125 may provide a value (e.g., an asserted value) for the invalidate pending bit 124 included in the queue entry 116 storing the first command. In this manner, the invalidate pending bit 124 provided to the queue entry 116 storing the first command may associate a queue state, such as “Invalidate Pending”, with the first command such that the first command may be removed from the queue 112, 114 before execution. Although an asserted invalidate pending bit 124 is employed by the apparatus 100 to associate a queue state with the first command, in other embodiments, a bit of another (e.g., a deasserted bit) value may be employed for associating a queue state with a command. Further, although an invalidate pending bit 124 is described above to associate a queue state with a command, in some embodiments, an encoding of a state, which may be represented by a plurality of bits, may be employed.

However, during operation, the apparatus 100 may (e.g., may only) select a command for removal from the queue if the command is associated with the queue state and does not depend on another command. More specifically, the command arbiter 126 may select a command from an entry 116 whose invalidate pending bit 124 is asserted and dependency valid bit 118 is not asserted. Therefore, while the first command depends on a second command, the command arbiter 126 may not select the first command for removal. However, in the manner described above, when the command arbiter 126 selects the second command for execution, the dependency valid bit 118 for one or more queue entries 116 including a pointer storing the number of the queue entry 116 storing the second command will be deasserted, thereby disassociating commands stored in the one or more queue entries 116 from the second command. In this manner, the association of the first command with the second command may be removed. Consequently, thereafter, the command arbiter 126 may select the first command for removal from the queue 112, 114 (e.g., before execution) and such command may be removed from the queue 112, 114.

Through use of the method 300 of storing a command, respective dependency valid bits 118, pointers 120 and linked bits 122 may be employed to track dependencies of queued commands referencing the same address. Additionally or alternatively, respective invalidate pending bits 124 may be employed for identifying a queued commands for removal from a queue 112, 114 before execution. By employing the bits and pointer described above, the present methods and apparatus may reduce an overall number of bits required to track dependencies of commands referencing the same address stored in one or more queues 112, 114 and/or accommodate removal of a command stored in a queue 112, 114 before execution, thereby reducing an area required by such methods and apparatus compared to conventional systems.

The foregoing description discloses only exemplary embodiments of the invention. Modifications of the above disclosed apparatus and methods which fall within the scope of the invention will be readily apparent to those of ordinary skill in the art. For instance, in some embodiments, during a time period (e.g., cycle), the command arbiter 126 may select a command from a queue 112, 114 for execution or select a command from a queue 112, 114 for removal. Alternatively, in other embodiments, the command arbiter 126 may select a command from a queue 112, 114 for execution and/or select a command from a queue 112, 114 for removal during the time period. In such embodiments, the logic 125 may be adapted accordingly. Further, although in some embodiments above an asserted dependency valid bit included in a queue entry 116 storing a command indicates the command depends on another command, in other embodiments, a deasserted dependency valid bit 118 makes such indication. Similarly, a deasserted linked bit 122 included in a queue entry 116 for storing a command may indicate the command has other commands which depend on it, and/or a deasserted invalidate pending bit 124 included in a queue entry 116 for storing a command may identify the command for removal before execution. In such embodiments, logic of the memory controller 106 may be adjusted accordingly. Further, although a dependency valid bit 118, linked bit 122 and invalidate pending bit 124 are described above, in some embodiments, an encoding of a state, which may be represented by one or more bits, may be used in lieu of the dependency valid bit 118, linked bit 122 and/or invalidate pending bit 124.

Accordingly, while the present invention has been disclosed in connection with exemplary embodiments thereof, it should be understood that other embodiments may fall within the spirit and scope of the invention, as defined by the following claims.

The invention claimed is:

1. A method of storing a command, comprising:
receiving a new command referencing an address;
determining whether the new command is dependent on at least one previously-received command referencing the address stored in a queue of pending commands;
identifying the most-recently received command of the at least one previously-received command; and
associating the new command with the most-recently received command of the at least one previously-received command.

2. The method of claim 1 wherein determining whether the new command is dependent on at least one previously-received command referencing the address stored in the queue of pending commands includes performing a lookup in a memory for the address referenced by the new command.

3. The method of claim 1 wherein identifying the most-recently received command of the at least one previously-received command includes identifying a previously-received command referencing the address stored in the queue of pending commands that does not depend on another command stored in the queue of pending commands.

4. The method of claim 3 wherein identifying a previously-received command referencing the address stored in the queue of pending commands that does not depend on another command stored in the queue of pending commands includes accessing a bit associated with the previously-received command referencing the address stored in the queue of pending commands indicating whether the previously-received command depends on another previously-received command.

5. The method of claim 1 wherein associating the new command with the most-recently received command of the at least one previously-received command includes setting a bit associated with the new command indicating whether the new command depends on a previously-received command.

6. The method of claim 1 further comprising:
selecting the most-recently received command of the at least one previously-received command for execution; and
disassociating the new command from the command selected for execution.

7. The method of claim 6 further comprising selecting the new command for execution.

8. The method of claim 6 further comprising associating a queue state with a first command stored in the queue of pending commands such that the first command may be removed from the queue of pending commands, before execution, based on the queue state.

9. The method of claim 1 further comprising associating a queue state with a first command referencing the address stored in the queue of pending commands such that the first command may be removed from the queue of pending commands, before execution, based on the queue state.

10. The method of claim 9 wherein associating a queue state with a first command referencing the address stored in the queue of pending commands includes setting a bit associated with such command stored in the queue of pending commands indicating whether the first command is to be removed from the queue of pending commands before execution.

11. The method of claim 10 further comprising removing the first command from the queue of pending commands before execution.

12. The method of claim 11 wherein the first command is associated with a second command referencing the address received before the first command; and
further comprising:
selecting the second command with which the first command is associated for execution; and
disassociating the first command from the second command.

13. The method of claim 9 further comprising:
selecting the most-recently received command of the at least one previously-received command for execution; and
disassociating the new command from the command selected for execution.

14. An apparatus for storing a command, comprising:
a processor;
a main memory; and
logic for storing a queue of pending commands, the logic includes a memory, is coupled to the processor and main memory, and is adapted to:
receive a new command referencing an address;
determine whether the new command is dependent on at least one previously-received command referencing the address stored in the queue of pending commands;
identify the most-recently received command of the at least one previously-received command; and
associate the new command with the most-recently received command of the at least one previously-received command.

15. The apparatus of claim 14 wherein the logic is further adapted to perform a lookup in the memory included in the logic for the address referenced by the new command.

16. The apparatus of claim 14 wherein the logic is further adapted to identify a previously-received command referencing the address stored in the queue of pending commands that does not depend on another command stored in the queue of pending commands.

17. The apparatus of claim 16 wherein the logic is further adapted to access a bit associated with the previously-received command referencing the address stored in the queue of pending commands indicating whether the previously-received command depends on another previously-received command.

18. The apparatus of claim 14 wherein the logic is further adapted to set a bit associated with the new command indicating whether the new command depends on a previously-received command.

19. The apparatus of claim 14 wherein the logic is further adapted to:
select the most-recently received command of the at least one previously-received command for execution; and
disassociate the new command from the command selected for execution.

20. The apparatus of claim 19 wherein the logic is further adapted to select the new command for execution.

21. The apparatus of claim 19 wherein the logic is further adapted to associate a queue state with a first command stored in the queue of pending commands such that the first command may be removed from the queue of pending commands, before execution, based on the queue state.

22. The apparatus of claim 14 wherein the logic is further adapted to associate a queue state with a first command referencing the address stored in the queue of pending commands such that the first command may be removed from the queue of pending commands, before execution, based on the queue state.

23. The apparatus of claim 22 wherein the logic is further adapted to set a bit associated with such command stored in the queue of pending commands indicating whether the first command is to be removed from the queue of pending commands before execution.

24. The apparatus of claim 23 wherein the logic is further adapted to remove the first command from the queue of pending commands before execution.

25. The apparatus of claim 24 wherein:
the first command is associated with a second command referencing the address received before the first command; and
the logic is further adapted to:
select the second command with which the first command is associated for execution; and
disassociate the first command from the second command.

26. The apparatus of claim 22 wherein the logic is further adapted to:
select the most-recently received command of the at least one previously-received command for execution; and
disassociate the new command from the command selected for execution.
